(19) United States
(12) Patent Application Publication
(10) Pub. No.: US 2002/0053283 A1
(43) Pub. Date: May 9, 2002

(54) Magnetic pollution filter

(76) Inventor: Saban Akyildiz, Harrison, NY (US)

Correspondence Address: GOTTLIEB RACKMAN & REISMAN PC, 270 MADISON AVENUE, 8TH FLOOR, NEW YORK, NY, 100160601

(21) Appl. No.: 09/947,321

(22) Filed: Sep. 6, 2001

Related U.S. Application Data
(60) Provisional application No. 60/246,305, filed on Nov. 7, 2000.

(51) Int. Cl. B03C 1/00

(52) U.S. Cl. 95/28; 96/1

(57) ABSTRACT

A filter for removing pollutants from gases, particularly exhaust gases, includes a plurality of paths for the gases to flow through and a source of magnetic field arranged to apply the magnetic field to the gases. Optionally, one or more heaters are also provide to raise the temperature of the gases to a predetermined temperature. As the hot gases through the passageway and the magnetic field, pollutants contained therein are effectively burned or otherwise removed from the gases.

### RELATED APPLICATIONS

This application claims priority to provisional application _____filed_____and entitled EXHAUST SYSTEM FOR ALL DIESEL AND GASOLINE APPLICATIONS, incorporated herein by reference.

### BACKGROUND OF THE INVENTION

A. Field of Invention

This invention pertains to a novel device and method for removing pollutants and other similar gaseous byproducts resulting from burning of fossil fuels, recyclable materials, garbage, etc. More particularly, the present invention pertains to a method and apparatus that includes a filter defining a passageway through which the gases are channeled and means for applying a magnetic field to these gases.

B. Description of the Prior Art

One of the biggest environmental problems facing the world today is atmospheric pollution. While some air pollution can be traced to natural causes, it is presently believed that a large portion of air pollution is produced by human activities and, more specifically, by burning of fossil fuels, garbage, recyclable materials and so on. Some progress has been made in reducing the production of pollutants. For example, cars and other vehicles using internal combustion engines are now equipped with catalytic converters. These converters are formed of honeycombed materials constructed and arranged to restrict the flow of exhaust gasses along predetermined paths while these gases are exposed to catalytic materials based usually on platinum and palladium.

In the presence of these catalysts certain chemical reactions take place that eliminate or at least reduce the amount of pollutants from the exhaust gases. However, catalytic converters have certain disadvantages. First, they require rare materials and hence are expensive. Second, they cannot be used with leaded fuel. Third, certain materials in the exhaust, and/or the atmosphere may interfere with the operation of these converters. Moreover, catalytic converters are not 100% efficient.

Other pollutant producing plants, such as incinerators, power plants, etc., use stack scrubbers for pollutant reductions. These scrubbers have similar disadvantages.

### OBJECTIVES AND SUMMARY OF THE INVENTION

An objective of the present invention is to provide a simple, inexpensive and effective filter for removing pollutants from gases, particularly exhaust gases.

A further objective is to provide a filter that uses in combination heat and a magnetic field to remove pollutants from gases.

A further objective is to provide a filter that is easily adapted to a variety of devices using internal combustion engines, diesel engines, other fossil fuel burning devices and generally to any apparatus that generates gases with pollutants.

Other objectives and advantages of the invention shall become apparent from the following description.

Briefly, a filter constructed in accordance with this invention includes a housing with a filter element or other similar means arranged and constructed to define paths for gases. Also includes is a source of magnetic field arranged to apply a magnetic field in a parallel with, or transversely to these paths. The gases may have sufficient heat to burn within the housing or alternatively, one or more heaters are included for heating the gases. The passage of gases through the paths and the magnetic field causes the pollutants to be removed or at least removed from the gases.

In one embodiment, the housing includes a filter element formed of one or more magnetized cores arranged along a common longitudinal axis and honeycombed to form the paths for the gases. The magnetized cores generate the magnetic field. In another embodiment, magnets are provided that are arranged to generate the required magnetic field.

A protective sheath is also provided around the core. The sheath can be made fiberglass, asbestos, etc, and is designed to absorb the heat generated by the gases during burning. The protective sheath also protects the filter element from mechanical vibrations.

### BRIEF DESCRIPTION OF THE DRAWINGS

FIG. 1 shows a side elevational orthogonal view of a magnetic filter element constructed in accordance with this invention;

FIG. 2 shows a side elevational view of a magnetic filter constructed in accordance with this invention and incorporating the filter element of FIG. 1;

FIG. 3 shows a cross-view of the filter of FIG. 2;

FIG. 4 shows a side elevational sectional view of the interior of an alternate embodiment of the invention; and

FIG. 5 shows a cross-sectional view of another embodiment of the invention.

### DETAILED DESCRIPTION OF THE INVENTION

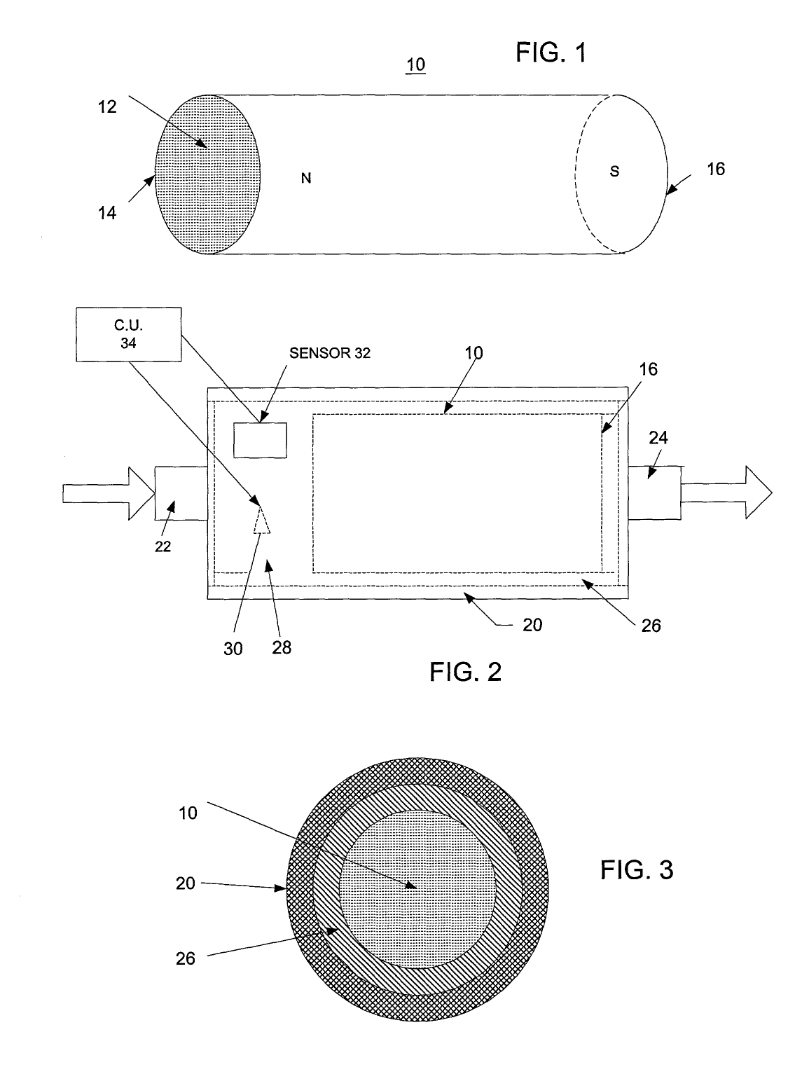

The present inventor has discovered that a very effective pollution filter can be constructed using a magnetic filter element and, optionally, a heater. A typical filter element 10 that can be used for this purpose is shown in FIG. 1. Filter element 10 is shown as having a cylindrical shape, however, it can have any desired shape as well. Importantly, the filter element or core 10 is made of a magnetic material that it is magnetized along its longitudinal axis to form magnetic North pole N and a magnetic South pole S as shown. The filter element 10 is honeycombed with a plurality of thin holes 12 extending from between the two ends 14, 16. Holes 12 can have a diameter in the order of magnitude of about 1mm. The filter element 10 may be made by casting, molding or other similar techniques. Alternatively, the filter element 10 may be made with a solid body and the holes 12 can be drilled through the body. The core 10 may be made of a standard magnetic material, a material generating a high strength material or an electromagnet.

Referring now to FIG. 2, the filter element 10 is shown incorporated into a magnetic pollution filter 18 having a housing 20 with a gas inlet 22 and a gas outlet 24. The housing 20 can be made of steel, aluminum or other similar materials.

Filter element 10 is disposed concentrically within the housing 20. Preferably a sleeve 26 is provided between the filter element 10 and the housing 20. This sleeve 26 may be made of a heat insulating material such as fiberglass, asbestos, etc. The sleeve 26 protects the filter element 10 from mechanical vibrations, and insures that the housing 20 does not overheat. At one end of the housing 20, for example, adjacent to the inlet 22, the housing 20 may be provided with a chamber 28. This chamber 28 is used to hold a heating element 30. Heating element 30 may comprise a glow plug, a spark plug adapted to generate arcs, an electrical heater with heating coil or other resistive heating element, and so on. Alternatively, the heating element 30 can be installed in the inlet 22. A single heating element 30 is shown in the drawings for the sake of clarity, however, it should be understood that a number of such elements may be provided as required, to heat the gases and the filter element 10 to a sufficiently high temperature to insure that the pollutants are burned. In order to insure that this temperature is high enough, a temperature sensor 32 is provided that senses the temperature of the gases. This temperature is sent to a control device 34. The control device 34 controls the operation of the heating element as required to maintain a predetermined temperature. The sensor 32 is shown disposed in chamber 28, however, it may also be positioned and arranged to sense the temperature at the inlet 22, outlet 24, and so on.

The magnetic pollution filter 18 operates as follows. The inlet 22 is coupled to the exhaust of a device or system producing exhaust gases with pollutants. For example the inlet 22 may be connected to the exhaust of the internal combustion engine of a car. As the exhaust gases flow into the filter 18, their temperature is detected by sensor 32 and fed to control device 34. The control device 34 determines if this temperature is high enough. If it is not, for example, if it is not at least 90-100° C. then the control device 34 activates the heater element 30. The gases flow through holes 12 of the filter element 12 and as they flow through these holes, they are subjected to the magnetic field of the filter element as well. During this process, the pollutants within the exhaust burn away, or otherwise removed or reduced. The cleaned gases are released or flow out of the filter 18 through the outlet 24.

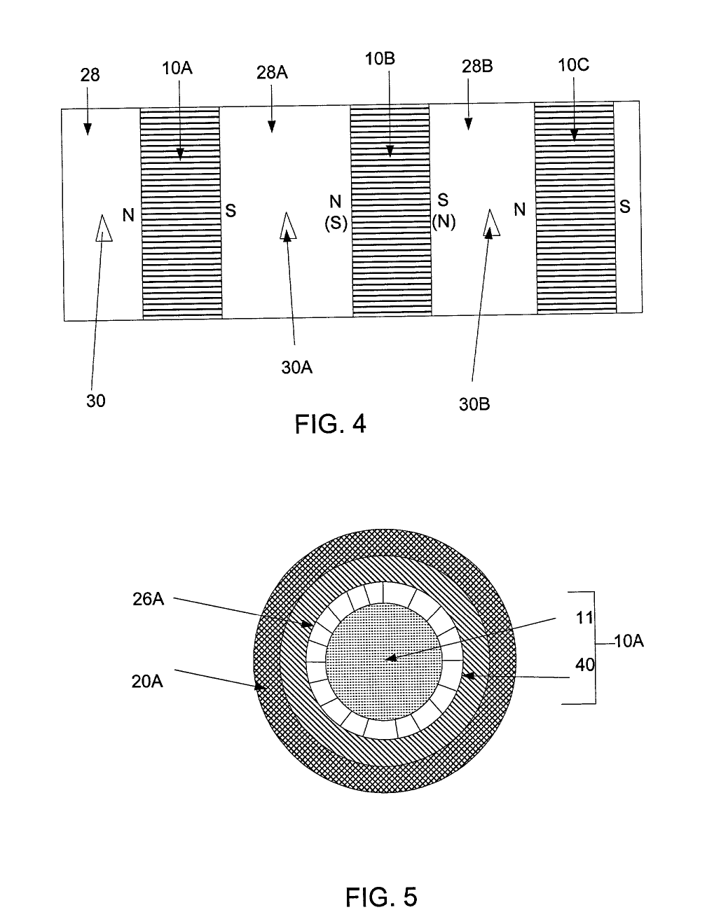

While in the preferred embodiment described above one filter element is shown, any number of such filters may be suitable. For example, in FIG. 4 shows an alternate embodiment of the invention in which, instead of a single filter element 10, three filter elements 10A, 10B and 10C are used, these filter elements being axially spaced along the longitudinal axis of the filter 18. The filter elements may be positioned the same direction, for example, with their North poles oriented toward the intake 22. The filter elements 10A, 10B, 10C can also be positioned so that they are not all oriented in the direction. For example, elements 10A, 10C can be positioned with their North poles facing the intake 22 while element 10B can be positioned with its North pole oriented toward the outlet 24 (as indicated in FIG. 4 by the letters in parentheses).

The filter elements are separated by respective heating chambers 28A, 28B. In each of these chambers a heater element 30A, 30B may be provided to heat the gases flowing therethrough and, indirectly, the filter elements 10A, 10B and 10C. These filter elements are also provided with holes that allow the gases to pass therethrough. The basic operation of this embodiment is the same as the operation of the embodiment in FIG. 2.

Another embodiment shown in FIG. 5. In this embodiment filter 18A is provided with a housing 20A, a sleeve 26A and a filter element 10A formed of a central core 11 surrounded by magnets 40. Core 11 may be made of ceramics, plastics or a metal which may or may not be magnetizable when exposed to a magnetic field. The core 11 also has small holes (not shown) for passing exhaust gases with pollutants. Magnets 40 are disposed circumferentially about the core 22. These magnets may be magnetized longitudinally, in a manner similar to filter element 10, or they may be magnetized radially. In this manner the magnets can generate magnet fields that can be parallel or transversal to the longitudinal axis of the housing and the flow of gases through the holes 12.

In all the embodiments exhaust gases with pollutants flow through the subject magnetic filter and are subjected to heat and a magnetic field which cause the pollutants to burn or otherwise be eliminated or at least reduced. As a result, the gases exiting from the magnetic filter have much lower level of pollutants then the gases entering the filter. These pollutants include unburned or partially burned fuel, Nox, carbon monoxide, and other green house effect gases.

The magnetic filter presented herein can be used in various industries and fields of applications associated with the generation of exhaust gases leaden with pollutants, such as motor vehicles and other apparatus having an internal combustion engine, including outboard and inboard motor boats, lawn mowers as well as other apparatus and plants such as apparatus with diesel engines, smoke stacks, coal, oi and other fossil fuel burners, incinerators etc.

The size and shape of the housing, 20, and the size, shape and number of filter elements may vary from application to application. For an automobile, the filter of FIG. 2 may be placed downstream of the muffler system and may have a length of about 1 1/2to 2 feet and a diameter of about a foot. When the filter is incorporated in or mounted on a motor vehicle, the heater elements can be powered from the battery of the vehicle. If the apparatus is fixed, the heater can be powered from outer electrical sources. In some applications, if the exhaust gases are hot enough (i.e. at least 90-100° C. the heaters may be omitted.

Obviously numerous modifications may be made to this invention without departing from its scope as defined in the appended claims.

I claim:

1. A magnetic filter for eliminating or reducing pollutants from exhaust gases, said filter comprising:
a housing having an inlet for receiving exhaust gases with pollutants, and an outlet; and
a magnetic filter element defining a plurality of flow paths for said exhaust gases between said inlet and the outlet;
wherein said exhaust gases flow from said inlet through said flow paths to said outlet while the pollutants in said exhaust gases are substantially reduced.

2. The magnetic filter of claim 1 further comprising a heater disposed in said housing and arranged to heat said exhaust gases.

3. The magnetic filter of claim 1 wherein said magnetic filter is magnetized in a direction parallel to said flow paths.

4. The magnetic filter of claim 1 wherein said magnetic filter is magnetized in a direction transversal to said flow paths.

5. The magnetic filter of claim 1 comprising a plurality of filter elements.

6. The magnetic filter of claim 1 wherein all the filter elements are oriented in the same direction.

7. The magnetic filter of claim 5 wherein said filter elements are oriented in alternate directions.

8. The magnetic filter of claim 1 wherein said filter element comprises a core honeycombed with holes.

9. The magnetic filter of claim 1 wherein said filter element comprises a magnetized core having a North and South pole.

10. The magnetic filter of claim 1 wherein said filter element comprises a nonmagnetized core and a plurality of magnets arranged to apply a magnetic field through said core.

11. The magnetic filter of claim 1 further comprising a protective sheath disposed about said filter element.

12. The magnetic filter of claim 1 wherein said protective sheath is adapted to provide shock absorption to protect said filter element from mechanical shocks.

13. The magnetic filter of claim 1 1 wherein said protective sheath is adapted to provide thermal protection.

14. A filter element for an apparatus adapted to eliminate pollutants from gases, said filter element comprising:
a core with a plurality of holes defining gas passages for the exhaust gases; and
means for applying a magnetic field to said core.

15. The filter element of claim 14 wherein said core is magnetized.

16. The filter element of claim 14 further comprising a plurality of magnets arranged to generate said magnetic field.

17. The filter element of claim 14 wherein said means is adapted to generate said magnetic field in parallel with the flow of gas through said core.

18. The filter element of claim 14 wherein said means is adapted to generate said magnetic field transversely to said flow of gas through said core.

19. The filter element of claim 14 wherein said core is made of a ceramic material.

20. The filter element of claim 14 wherein said core is made of a metallic material.

21. A filter for removing pollutants from gases comprising:
an elongated housing having a gas inlet and a gas outlet;
a plurality of pathways defined between said gas inlet and said gas outlet; and
a magnetic field source arranged to apply a magnetic field applied to the pathways.

22. The filter of claim 21 further comprising a heater adapted to apply heat to said gases.

23. The filter of claim 22 wherein said elongated housing is adapted to form a heating chamber, wherein said heater is disposed in said heating chamber.

24. The filter of claim 21 further comprising a core honeycombed with passageways.

25. The filter of claim 24 wherein said core is magnetized.

26. The filter of claim 24 further comprising a plurality of magnets arranged about said core to generate said magnetic field.

27. The filter of claim 21 further comprising a plurality of honeycombed cores.

28. The filter of claim 27 wherein said housing has a longitudinal axis and said cores are spaced along said axis.

29. The filter of claim 27 wherein housing and said cores cooperate to generate a plurality of heating chambers, said filter further comprising a plurality of heaters arranged in said heating chambers to heat gases flowing through said paths.

30. The filter of claim 22 wherein said heater is an electric heater.

31. The filter of claim 30 wherein said heater is a heat plug.

32. The filter of claim 30 wherein said heater is a resistive heating coil.

33. The filter of claim 30 wherein said heater is a wire mesh.

34. The filter of claim 21 further comprising a protective sleeve disposed around said passageway.

35. The filter of claim 34 wherein said protective sleeve is a thermal protective sleeve.

36. The filter of claim 34 wherein said protective sleeve is arranged to absorb mechanical vibrations.

37. The filter of claim 21 wherein said pathways comprise holes having a diameter of about 1mm.

38. A method of removing pollutants from gases comprising:
passing hot gases through a plurality of holes; and
applying a magnetic field to said gases to cause the pollutants to be removed from said gases.

39. The method of claim 38 further comprising heating said gases.

40. The method of claim 39 further comprising heating said gases to at least 90-100° C.
